(19) United States
(12) Patent Application Publication
(10) Pub. No.: US 2003/0031887 A1
(43) Pub. Date: Feb. 13, 2003

(54) Aluminum paper

(75) Inventors: Narsimhan Raghunathan, Beverwijk (NL); Jean Ann Skiles, Gibsonia, PA (US); Richard Davis, Surrey (GB)

Correspondence Address: ALCOA INC, ALCOA TECHNICAL CENTER, 100 TECHNICAL DRIVE, ALCOA CENTER, PA, 15069-0001, US

(73) Assignee: Alcoa Inc.

(21) Appl. No.: 10/192,904

(22) Filed: Jul. 10, 2002

Related U.S. Application Data
(60) Provisional application No. 60/304,673, filed on Jul. 11, 2001.

(51) Int. Cl. H01F 3/02

(52) U.S. Cl. 428/566; 428/650; 428/654

(57) ABSTRACT

An artificial paper having a porous aluminum foil as the substrate and a writable coating thereon, which includes aluminum trihydrate and other optional whitening agents to facilitate the writability of the substrate. The artificial paper has properties, such as writability, optical properties, mechanical properties, and durability equivalent to or superior to pulp-based paper.

### RELATED APPLICATION

This application claims the benefit of U.S. Provisional Patent Application No. 60/304,673 filed Jul. 11, 2001 entitled “Aluminum Paper.”

### FIELD OF THE INVENTION

The present invention relates to paper used for graphic arts purposes, more particularly to an artificial paper having an aluminum substrate.

### BACKGROUND OF THE INVENTION

About 70 million tons of paper for writing, printing, and the like are produced yearly worldwide. Nearly all of these paper products are manufactured from natural cellulose fibers derived from wood (soft and hard), as well as from plants such as bamboo, straw, and reeds. The process of converting the basic raw material to a finished paper is very long, often involving in excess of 40 unit operations, and generates a considerable amount of aqueous effluents with undesirable contaminants and waste.

In conventional paper manufacturing processes, cellulose fibers are separated from other plant materials, such as lignin, by either mechanical and/or chemical means in pulping mills followed by several stages of cleaning and bleaching to make the fibers white and clean. The purified fibers are supplied to a paper mill as dried or semi-dried bales. The bales are subjected to aqueous treatment to form a high solids suspension, termed a stock. In case of an integrated paper mill, the pulp mill may supply the fibers directly in the form of a suspension. The cellulose fibers are highly hygroscopic and must be made unreactive to fluid. This is achieved via an internal sizing process in which the fiber suspension is treated with soaps, such as rosin soaps. Rosin soaps are partially saponified colophonium dispersants, which upon reacting with aluminum sulfate, deposit on the fiber as aluminum resinates. The stock may contain other additives, such as fillers, fiber strengtheners, optical brighteners, and dyes for color papers. The stock is fed into a sheet forming machine having a set of fixed or mobile sieves (Fourdrinier sieves) to filter the water and produce a solid sheet, termed a paper web. The paper web is compacted further to a base paper material using a series of rubber-coated rollers. At this stage, the paper may not be of sufficient quality for conventional printing and writing and must be further processed via surface sizing and/or coating. The additional processing may include dipping the base paper material in a water based slurry containing whitening agents, such as kaolin clay or calcium carbonate and passing the resultant coated paper through another series of heated rollers (a calendering process) to evaporate the water. The slurry may also contain natural or synthetic binders to enhance adhesion of the whitening agents to the paper web and minimize powdering. To improve paper qualities such as opacity, whiteness, writability, and the like, the slurry may also contain pigments such as titanium dioxide, calcium sulfaluminate, and aluminum trihydrate.

The paper thus produced may weigh about 80 to 225 grams per square meter (g/m²) and should posses certain properties such as tear strength, stiffness, printability, and writability. The basic elements of paper technology, as described above, have remained more or less unchanged for decades, although there have been some developments of late.

Some of the recent developments have been aimed at minimizing the use of natural fibers. A major problem the paper industry is facing is the need to process a very large quantity of raw material. This is due to the fact that the natural products, such as wood contain only a limited amount of usable fibers, typically about 32 to 50% cellulose and 27 to 35% hemicellulose. In addition, the chemical nature of the pulping process further degrades the fibers and reduces their length. Thus, on an average, to obtain roughly one ton of useful fibers from these raw materials, it is often necessary to process two to three times the amount of the raw material leading to a large amount of waste products for disposal.

One way to minimize the demand for fresh fiber is to extract the fibers back from used paper in a recycling process. Due to various problems, including a lack of collection infrastructure, at present a maximum of only about 30% of paper is recycled. Hence, paper producers must rely upon fresh plant sources for the remainder. Repeated recycling of paper is often limited due to the chemical nature of the papermaking process and because the cellulose fibers degrade completely after one or two recycling processes. There have also been some attempts to replace cellulose fibers at least in part by more durable, synthetic fibers, such as nylon, but this has achieved only limited success.

Despite the increasing popularity of magnetic and other information storage devices, the demand for paper products is steadily rising. With the increasing pressure for environmentally compatible writing materials, a need remains for an artificial paper, which can be produced cost effectively with minimal waste and which is readily and repeatedly recyclable.

### SUMMARY OF THE INVENTION

This need is met by the artificial paper of the present invention which includes a foil substrate of metal, in particular aluminum or an aluminum alloy. The foil substrate preferably is coated with a composition containing aluminum trihydrate (a white mineral having unique characteristics for writability, printability, and whiteness) and a binder. In order to enhance the adhesion of the coating composition to the substrate, the foil may be porous.

### DETAILED DESCRIPTION OF THE INVENTION

The present invention includes an artificial paper referred to hereinafter as a writable member. By the phrase “artificial paper” it is meant that the writable member does not include cellulose fibers or other plant materials of natural origin. The term “writable” and variants thereof (e.g., “writing”) used herein are not meant to be limiting as they are intended to refer to and include other forms of marking the product of the present invention including printing, painting, coloring, and the like. In addition, the phrase “writable member” is intended to encompass a member, that is writable by various conventional aqueous compositions or organic solvent based compositions, such as inks and paints and by dry materials, such as pencil, chalk, and crayon. Other writing materials and implements may be used with the writable member of the present invention, including writing materials and implements that are currently not conventionally used with pulp-based paper but which may be suitable for use with the writable member of the present invention.

The writable member of the present invention includes a substrate and a writable coating thereon. The substrate preferably is a foil of aluminum or an aluminum alloy such as an Al—Fe—Si alloy. The aluminum alloy may include other incidental impurities or microalloying elements, such as magnesium, copper, etc. The alloy may be derived from virgin metal sources or from scrap. The alloy may be processed by conventional foil making process, such as by casting the alloy into a thick slab followed by hot and cold rolling to finished gauge with one or several intermediate annealing steps. More preferably, the alloy may be continuously cast directly into a thin strip by conventional roll or belt casting processes and then rolled into a foil of required thickness. Currently available milling technologies allow production of foils as thin as about 6 μm at widths of up to about 2 meters. These limits are not necessarily fixed and may change in the future with the development of milling processes. Thus, it may be possible to produce foils much thinner and in much wider widths by the traditional rolling process. Alternatively, processes which are under development now, such as electrolytic deposition of aluminum into foils directly from bauxite, may be used to produce foils of much thinner gauge and wider widths at much lower cost than rolled foils.

The foil may be perforated to reduce the cost of the substrate and enhance the adhesion of the writable coating thereon. While several mechanical and chemical means to perforate a foil are available, it is preferred to perforate the foil as part of the foil production operation for minimizing cost.

One such method of producing perforated foil is mechanical in nature. Lubricants used in foil rolling mills may be mixed with certain fine hard particles, such as diatomaceous earth (e.g. silica). The particles create very fine perforations in the foil as it is rolled in a controlled manner producing an integrally perforated foil.

A second method of producing perforated foil is also mechanical in nature. The surfaces of the work rolls of foil rolling mills are normally ground to a specific roughness in order to optimize mill running parameters and give a certain foil brightness. The surface texture of the work rolls is controlled to have raised portions (peaks) in order to create a predetermined level of surface damage or ruptures in the foil during a single rolling pass or multiple rolling passes, which results in a uniform distribution of perforations in the finished foil.

A metallurgical route to producing perforated foils takes advantage of centerline segregation that occurs during roll casting or belt casting of certain alloys. Hard intermetallic particles containing elements such, as Al, Fe, Si, Mn, and Cu segregate in the center regions of the strip of cast alloy. When such a strip is rolled into foil gauge, these hard particles tend to perforate the foil. In conventional foil applications such perforations are undesirable, and thus extreme care is typically taken to avoid them. However, for the present invention, these common defects are considered beneficial, since they help to enhance the adhesion of the writable coating to the surface and reduce the amount of aluminum in the foil and, hence, the cost.

The foil surface may further be treated to enhance the adhesion of the writable coating by either mechanical or chemical means or a combination of both. If the writable coating adheres too tightly to the substrate, the removal of the writable coating from the foil substrate during subsequent recycling may be difficult.

The writable coating composition applied to the foil substrate of the present invention contains a mineral, such as aluminum trihydrate and a binder to bind the minerals to the foil surface. Other minerals, such as calcium carbonate, titanium oxide, calcium sulfaluminate (satin white), talc, or other materials of synthetic origin normally used in conventional papermaking may also be used alone or in combination with aluminum trihydrate to enhance writability. The coating composition may contain other ingredients, such as optical brighteners used in the current papermaking operations, derived from diaminostilbenediesulphonic acid or other such chemicals, to achieve a whiter visual appearance. The coating composition may also contain colorants for colored papers, and these may be based on natural color pigments, such as ferric oxide or chromic oxide (or their synthetic counterparts), which are used in conventional papermaking. The size, shape, and chemical nature of the above minerals and pigments preferably provide a smooth writable surface compatible with the currently available ink technology and for practical purposes may be similar to that used in conventional papermaking. The coating composition may further contain dispersants, such as polyphosphoric acids or polyacrylic acids, to ensure that the aluminum trihydrate and other minerals are well dispersed throughout the coating. The binder may be based on natural materials, such as starch, cellulose esters, casein or soybean protein. Alternatively, synthetic binders, such as dispersions based on polymers, such as styrene, butadiene, vinyl acetate, acrylic esters, or acrylonitrile (alone or in combination with other monomers, such as acrylic acid and maleic acid to enhance the dispersion properties of the binder particles) may be used. The components of the coating composition are mixed with a carrier, preferably water, to form a slurry, the constitution of which is adjustable so that the slurry may be used with conventional coating equipment.

The coating composition may be applied to the foil substrate in conventional roll coating processes, such as used in painting operations or via extrusion coating followed by a drying step to remove the water or other carrier fluid. Both sides of the foil substrate may be coated with the same composition, or only one side may be coated or each side may be coated with different compositions depending on the end use of the writable member. The weight and the thickness of the coating may be adjusted to meet the requirements of writability or ink absorption.

Advantages of the writable member of the present invention include (1) the ability to produce a writable member with a minimum number of processing steps, particularly as compared to the production of traditional pulp-based paper, (2) production at a price competitive to production of pulp-based paper, (3) significantly longer shelf life than that of traditional pulp-based paper, and (4) the ability of the substrate to be recycled many times without degradation. The writable member of the present invention should have product attributes at least comparable to pulp-based paper.

Opacity is one of the major requirements of graphic arts paper used for printing and writing. Percent opacity refers to the amount of visible light blocked by the material. Great effort is taken to obtain high opacity levels (greater than 90%) in pulp-based paper. This is typically achieved by maintaining a certain minimum weight and caliper of the paper web and by using large quantities (greater than 30% by weight of the final paper) of fillers and pigments that lead to considerable weight and bulkiness of the pulp-based paper. The metal foil used in the writable member of the present invention is inherently opaque. A very thin foil with uniformly distributed perforations of submicron size may have an opacity in excess of 95%. The thin coating on top of the foil may further enhance opacity. Other attributes, such as tensile strength, tear strength, burst strength, tear growth resistance, and bending stiffness of the writable member of the present invention may be superior to pulp-based paper by virtue of the substrate being metallic. In addition, the writable member of the present invention may be much lighter in weight than comparable pulp-based paper. Typical lightweight bond paper weighs in excess of 50 g/m² including the paper web, the fillers, and coating. It is difficult to reduce the weight further without sacrificing other properties such as opacity, tear resistance, burst strength, etc. Aluminum foil substrate of the present invention about 6 μm thick would weigh about 17 g/m². By perforating the aluminum foil substrate as described above, this weight may be further reduced to less than 10 g/m² without seriously affecting other properties, such as mechanical properties or optical properties. The complete writable member including the coating may weigh less than 12 g/m² leading to a reduction in weight over a comparable lightweight bond paper of more than 70%. This weight reduction helps to make the foil substrate more attractive for economic reasons and reduces the bulk and the caliper of the paper, which is desirable for graphic arts applications, such as books. Other attributes including moisture resistance and reactivity to fluids are inherently superior in the writable member of the present invention due to the fact the substrate is unreactive to water and other fluids, while such features can be obtained in pulp-based papers only with considerable effort.

Another area of import is the shelf life and durability of papers. Despite the considerable efforts taken by paper manufacturers, durability and shelf life measured in terms of fold resistance of pulp-based paper are not very high. In the best case scenario the durability of pulp-based paper is less than five years. This is due to the acid nature of the process of paper making itself and corrosion of paper by the ambient moisture and other chemical pollutants present in the environment. In this regard, the writable member of the present invention based on metal foil may have substantially long shelf life and durability, since the process of making the substrate does not involve any use of corrosive chemicals. The coating that is applied on the foil substrate may be done under mostly neutral pH conditions or in alkaline conditions.

### EXAMPLES

Aluminum alloy foils (household grade, 0.00075 and 0.0015 inch thick) sized about 11×17 in² having a matte finish side and a dull finish side were cleaned with acetone. A coating composition of silica, aluminum trihydrate and latex binder (50% water) in a 5:1:1 ratio was applied to both sides of the foils by spraying the coating composition onto the foil at 60 psi at a spray orifice to foil distance of about 12 inches. The coatings were dried in a 60° C. convection oven for 2 minutes. Up to five layers of the coating composition were applied to each side of the foils for a calculated maximum coating thickness of about 4.5 μm per side.

The coated foils and controls of 40 supercalendar paper were print tested on an Epson 400 color ink jet printer, off-set lithographic printer and a flexographic stamp. All samples were tested for whiteness (L value) using an X-Rite portable spectrophotometer and for roughness in a Sheffield test. The maximum L value achieved for the foils was acceptable at 84.63 (dull side) at five layers of the coating composition which was slightly less than the L value for the paper of 97.69. Roughness for the foils was about 300 on the Sheffield scale versus single digits for the paper. Multiple layers of the coating composition provided greater whiteness yet with higher roughness and somewhat reduced print resolution. Hence, the product of the present invention may be particularly suited for applications where whiteness or texture is not critical, such as for packaging labels or arts and crafts materials.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A writable member comprising:
a substrate comprising aluminum alloy foil; and
a writable coating positioned on one side of said substrate.

2. The writable member of claim 1, wherein said writable coating contains aluminum trihydrate.

3. The writable member of claim 2, wherein said writable coating further contains one or more additives selected from the group consisting of a whitener, an optical brightener, a colorant, and a dispersant.

4. The writable member of claim 3, wherein said whitener is selected from the group consisting of calcium carbonate, titanium oxide, calcium sulfaluminate, and talc.

5. The writable member of claim 3, wherein said optical brightener is diaminostilbenediesulphonic acid.

6. The writable member of claim 3, wherein said colorant is ferric oxide or chromic oxide.

7. The writable member of claim 3, wherein said dispersant is polyphosphoric acid or polyacrylic acid.

8. The writable member of claim 2, further comprising a binder.

9. The writable member of claim 8, wherein said binder is selected from the group consisting of styrene, butadiene, vinyl acetate, an acrylic ester, and acrylonitrile.

10. The writable member of claim 1, wherein said foil defines a plurality of perforations.

11. The writable member of claim 10, wherein said perforations are rolled into said foil.

12. The writable member of claim 11, wherein said foil is rolled with additive particles to perforate said foil.

13. The writable member of claim 11, wherein said foil is rolled with rolls having a textured surface with raised portions to perforate said foil.

14. The writable member of claim 11, wherein said alloy contains intermetallic particles which perforate said foil.

15. The writable member of claim 1, wherein said writable member weighs up to about 20 g/m².

16. The writable member of claim 1, wherein said writable member weighs up to about 17 g/m².

17. The writable member of claim 1, wherein said writable member weighs up to about 10 g/m².

18. The writable member of claim 1, wherein said writable member has an opacity of over about 95%.

19. A method of making a writable member comprising the steps of:
rolling an aluminum alloy into a foil between a pair of work rolls; and
applying a writable coating composition onto one surface of the foil.

20. The method of claim 19 wherein said rolling step further comprises producing a plurality of perforations in the foil.

21. The method of claim 20 wherein at least one of the work rolls has a textured surface with raised portions, such that the raised portions produce the perforations in the foil.

22. The method of claim 20 wherein said rolling step further comprises providing particles on at least one of the work rolls, such that the particles produce the perforations in the foil.

23. The method of claim 20 wherein said rolling step causes the aluminum alloy to form intermetallic particles which produce the perforations in the foil.

24. The method of claim 19 wherein said applying step comprises roll coating the writable coating composition onto the foil surface.
